(19) United States
(12) Patent Application Publication
(10) Pub. No.: US 2012/0173962 A1
(43) Pub. Date: Jul. 5, 2012

(54) ONLINE APPLICATION PROVIDING APPARATUS

(75) Inventors: Byeong Thaek OH, Daejeon (KR); Hee Sun WON, Daejeon (KR); Sung Jin HUR, Daejeon (KR)

(73) Assignee: Electronics and Telecommunications Research Institute, Daejeon (KR)

(21) Appl. No.: 13/341,329

(22) Filed: Dec. 30, 2011

(30) Foreign Application Priority Data
Dec. 30, 2010 (KR) 10-2010-0138798

(51) Int. Cl. G06F 17/00

(52) U.S. Cl. 715/234

(57) ABSTRACT

An online application providing apparatus includes: a rendering unit; a metadata manager; a database; and a view resolver. When a web page URL is requested from a user terminal in a tenant, the rendering unit requests UI data to the metadata manager for generating code data corresponding to the URL, provides, to the view resolver, the code data to which a flexible field corresponding a UI page specified for the tenant is applied, and the view resolver generates an actual web based UI code by using the code data provided from the rendering unit and transmits the actual web based UI code to the user terminal.

### CROSS-REFERENCE(S) TO RELATED APPLICATION(S)

The present invention claims priority of Korean Patent Application No. 10-2010-0138798, filed on Dec. 30, 2010, which is incorporated herein by reference.

### FIELD OF THE INVENTION

The present invention relates to an online application providing apparatus; and more particularly, to an online application providing apparatus providing an individualized application corresponding to each of tenants by setting the application to be customized for each tenant with a flexible data field and metadata other than conventional fixed data field.

### BACKGROUND OF THE INVENTION

Generally, application providing method of application service provider (ASP) via an internet is used. Here, the ASP is a method that application user can use an online application by paying monthly fixed fee or paying rental fee proportional to used time for the online application.

This application market is increased rapidly since IT infra is being extended due to the extension of a dedicated line and application user can use an online application at a low price. The application market is predicted to grow largely hereinafter.

However, according to the conventional technique, a conventional direct installation model or an online ASP model providing an online application provides mostly a group ware, a CRM and an ERP solution in one-to-one type. Namely, one application is matched to one user and many customizing elements are required for make the application be suitable for the corresponding user when first installation. Thus, installation cost for the application can be high and management for the application can be difficult.

In addition, economy of scale is difficult to be realized since application instance should individually managed and the corresponding database should be provided to the user in one-to-one type.

### SUMMARY OF THE INVENTION

In view of the above, the present invention provides an online application providing apparatus providing an individualized application corresponding to each of tenants by setting the application to be customized for each tenant with a flexible field and metadata other than conventional fixed data field.

In accordance with an aspect of the present invention, there is provided an online application providing apparatus including: a rendering unit; a metadata manager; a database; and a view resolver.

When a web page URL is requested from a user terminal in a tenant connected with the online application providing apparatus via a communication network, the rendering unit requests UI data to the metadata manager for generating code data corresponding to the URL and provides, to the view resolver, the code data to which a flexible field corresponding a UI page specified for the tenant is applied.

Further, when the request of the UI data generating the UI is received from the rendering unit, the metadata manager requests necessary data for processing the request to the database, and transmits the UI data generated based on the necessary data received from the database in response to the request to the rendering unit.

When the database receives the request of the corresponding data, the database extracts the corresponding data to the request and provides the extracted data to the metadata manager. Further, the view resolver generates an actual web based UI code by using the code data provided from the rendering unit and transmits the actual web based UI code to the user terminal.

In accordance another aspect of the present invention, there is provided an online application providing apparatus including: an application unit; a metadata manager; and a database.

When a data request of actual application data for a UI occurs from a user terminal in a specific tenant connected via a communication network with the online application providing apparatus, the application unit selects an application business logic corresponding to the data request and requests the data to the metadata manager.

The metadata manager requests corresponding data to the database for processing the request, receives the corresponding data from the database and converts the received data into fixed field model object and a specific code type of flexible field data.

Further, when the corresponding data for processing the request is requested, the database extracts the corresponding data and transmits the extracted data to the metadata manager.

In accordance with still another aspect of the present invention, there is provided an online application providing apparatus including: an application unit; a metadata manager; and a database.

When storing or updating data is requested from a user terminal in a specific tenant connected via a communication network with the online application providing apparatus, the application unit separates the data to be stored or updated into code type data of a flexible field and a fixed field model object.

The metadata manager generates a data model by using the code type data of the flexible field and the fixed field model object separated from the data requested to be stored or updated and requests for the storing or the updating the database, and the database performs the storing or the updating of the data by using the data model.

### BRIEF DESCRIPTION OF THE DRAWINGS

The objects and features of the present invention will become apparent from the following description of embodiments, given in conjunction with the accompanying drawings, in which:

FIG. 1 is a block diagram showing a network configuration of an online application providing system in accordance with an embodiment of the present invention;

FIG. 2 is a specific block diagram of an online application providing apparatus in accordance with the embodiment of the present invention;

FIGS. 3A and 3B respectively illustrate examples of a basic list display and a list display where a flexible field is added in accordance with the embodiment of the present invention;

FIG. 4 shows an example of a screen where DB scheme is mapped to an UI component in accordance with the embodiment of the present invention;

FIGS. 5A and 5B illustrate a flowchart of a rendering process of a web based UI in accordance with the embodiment of the present invention;

FIGS. 6A and 6B depict a flowchart showing that a web browser of a user terminal brings an actual data necessary for loading a web page in accordance with an other embodiment of the present invention; and

FIG. 7 is a flowchart showing a data processing and an update processing of a user terminal in accordance with still another embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, an embodiment of the present invention will be described in detail with the accompanying drawings which form a part hereof.

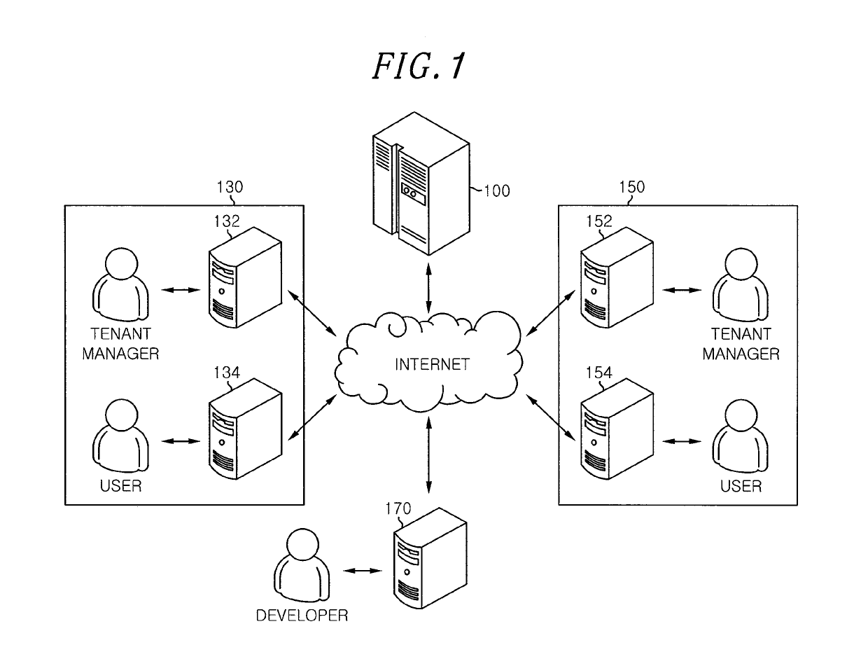

FIG. 1 is a block diagram showing a network configuration of an online application providing system in accordance with an embodiment of the present invention.

Hereinafter, each part of the online application providing system will be described by referring to FIG. 1.

First, an online application providing apparatus 100 sets an online application environment of a tenant according to a request of a tenant manager of the tenant.

In addition, the online application providing apparatus 100 provides an individualized online application according to the set online application environment to manager terminals 132 and 152 and user terminals 134 and 154 included in the corresponding tenant. Herein, the tenant means a user group such as a company, an organization and an association or the like. Namely, the tenant is a user group in which a plurality of the user terminals 134 and 154 using a similar type application are included. Each tenant may include the manager terminals 132 and 152 and a plurality of the user terminals 134 and 154.

The manager terminals 132 and 152 set and manage the online application environment of a tenant to be suitable for the corresponding tenant. Namely, the manager terminals 132 and 152 individualize the online application to be suitable for an application use environment of the user terminals 134 and 154 in the tenant together with the online application providing apparatus 100. Herein, the manager terminals 132 and 152 perform the function of the user terminal which uses the online application according to the application use environment.

The user terminals 134 and 154 access the online application providing apparatus 100 via an internet and use an online application according to the application use environment set by the manager terminals 132 and 152.

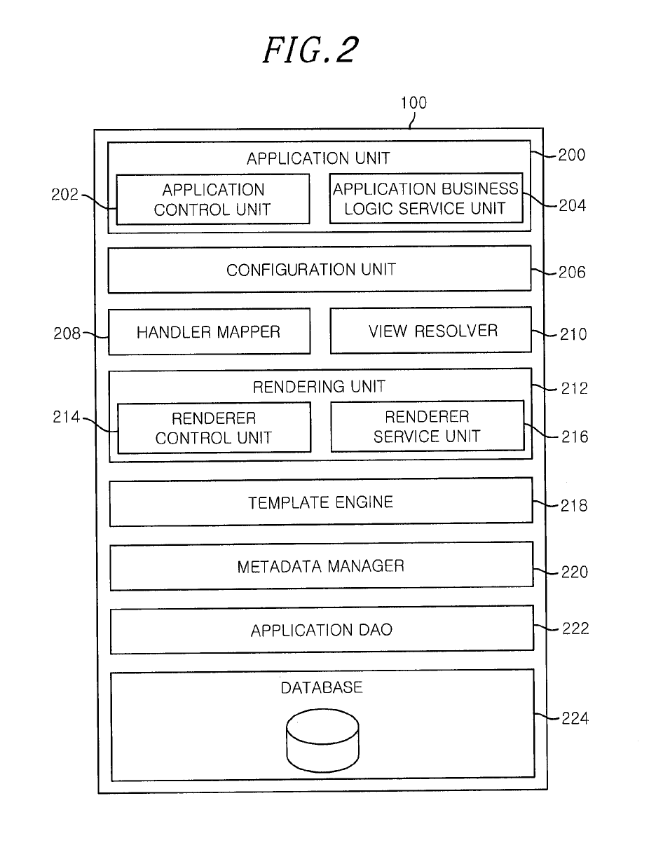

FIG. 2 is a specific block diagram of the online application providing apparatus 100 in accordance with the embodiment of the present invention.

Referring to FIG. 2, the online application providing apparatus 200 includes an application unit 200, a configuration unit 206, a handler mapper 208, a view resolver 210, a rendering unit 212, a template engine 218, a metadata manager 220, an application DAO (Data Access Object) 222 and a database 224.

When a specific URL page of a specific tenant is requested from a web browser of the user terminals 134 and 154, the handler mapper 208 performs handler mapping corresponding to the requested URL page.

The rendering unit 212 includes a renderer control unit 214 and a renderer service unit 216, and performs a function of generating a specific user interface (UI) page of a specific tenant and bringing the specific UI page.

When the URL page request is received from the handler mapper 208, the renderer control unit 214 requests generating a javascript code for configuring the UI of the URL page requested from the user terminals 134 and 154 to the renderer service unit 216.

The renderer service unit 216 requests a UI component model object for configuring the requested URL page to a metadata manager 220 and receives the UI component model object. Then, the renderer service unit 215 requests generating javascript code to a template engine 218 by transmitting a hash map, the UI component model object and a template code for the corresponding UI and transmits a javascript code received from the template engine 218 to the renderer control unit 214.

The template engine 218 generates a javascript for configuring the requested URL page in the user terminals 134 and 154 by using the UI component model object, the template code and the hash map transmitted from the renderer service unit 216 and transmits the javascript to the renderer service unit 216.

When the metadata manager 220 receives a request for data relating to the UI component for the URL page requested from the user terminals 134 and 154, the metadata manager 220 requests the corresponding data to a database 224 by generating SQL sentence, generates UI component model object by using data received from the database 224 and provide the renderer service unit 216 with the UI component model object.

The application unit 200 includes an application control unit 202 and an application business logic service unit 204.

When URL data is requested from the web browser of the user terminals 134 and 154, the application control unit 202 calls the corresponding application business logic service unit 204 and processes the requested URL data.

Namely, the application control unit 202 requests a data process by requesting a call of a method for performing the URL data process to the application business logic service unit 204. Then, the application business logic service unit 204 calls a metadata manager API of the metadata manager 220 for performing the corresponding data process via the application DAO 222 and performs the data process.

When the call for the metadata manager API for URL data processing is requested from the application business logic service unit 204, the metadata manager 220 requests the corresponding data to the database 224 and receives the data. Then, the metadata manager 220 generates relation data of a fixed field in a form of model object, generates flexible field data in a form of JSON type or XML code type, and provides the application business logic service unit 204 with the relation data of fixed field and the flexible field data.

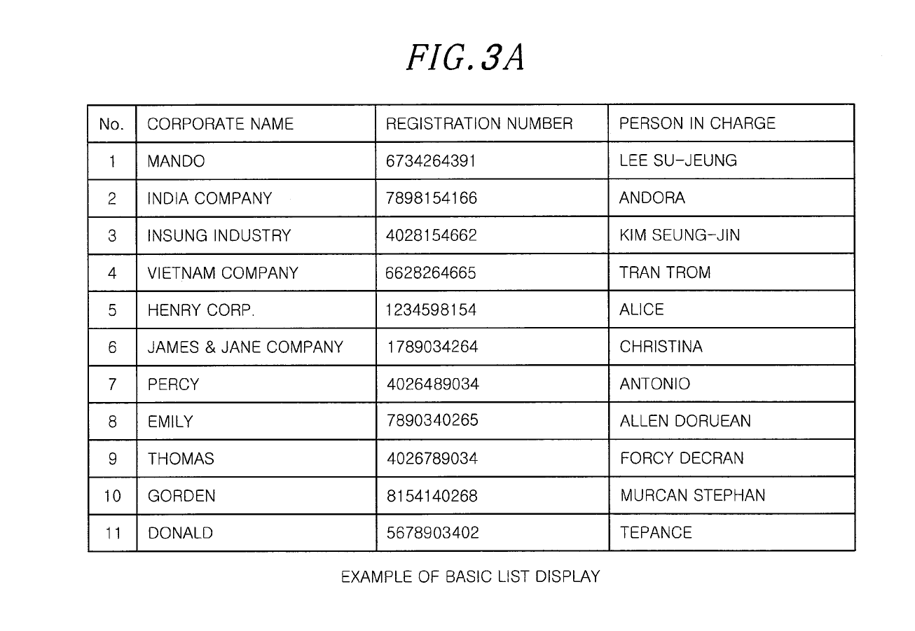

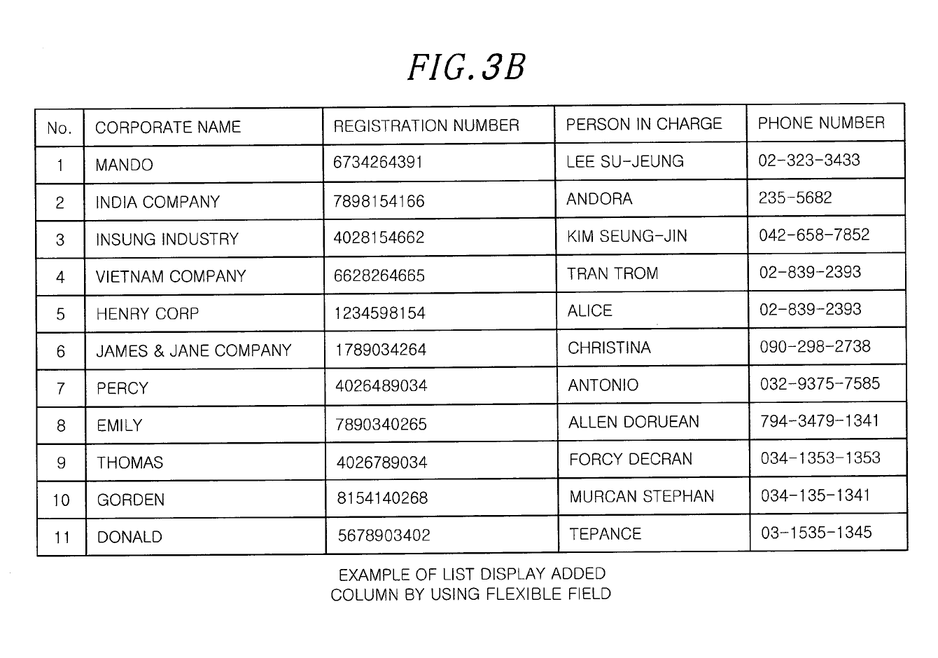

As shown in FIGS. 3A and 3B, the online application providing apparatus 100 may have expansibility and flexibility since a tenant manager may add flexible data field to the data list UI of a basic application developed by an application developer and thus, the tenant manager can use the individual application for the tenant. Herein, the tenant manager decides that ‘phone number’ field shown in FIG. 3B is necessary and the tenant manager sets the ‘phone number’ field by using the flexible field.

The embodiment of the present invention may be implemented by a basic table such as the following table 1 and a table such as the following table 2 including mapping information of flexible field for each tenant and setting information for each tenant. The flexible field as shown in the following table 2 includes a various type of information and a type of the information is stored in a different table.

TABLE 1
COMPANY

| | |
|---|---|
| COMPANY_ID | INT |
| COMPANY_NAME | VARCHAR |
| BIZ_REGIST_NUM | VARCHAR |
| PERSON_IN_CHARGE_NAME | VARCHAR |

TABLE 2

| | |
|---|---|
| TENANT_ID | INT |
| C_FLEX1 | VARCHAR |
| C_FLEX2 | VARCHAR |
| C_FLEX3 | VARCHAR |
| C_FLEX4 | VARCHAR |

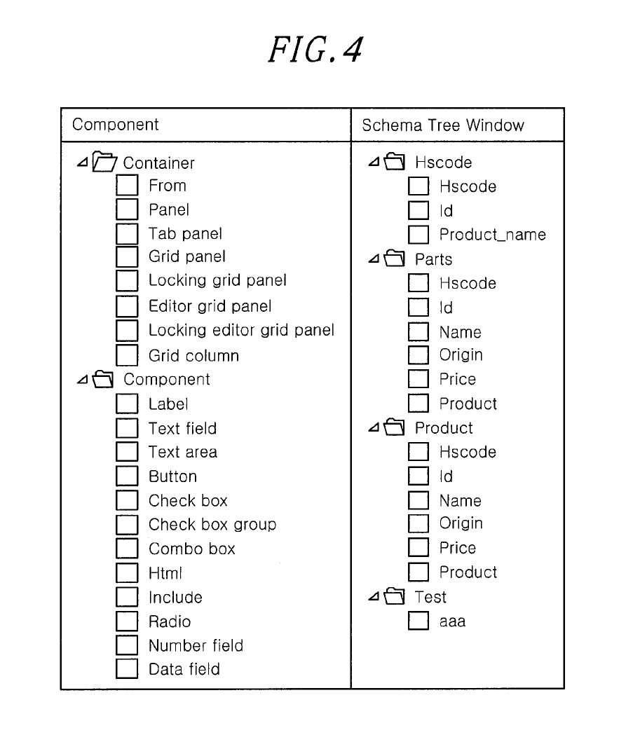

Herein, it is assumed that each available UI component based on a web is already stored in a form of metadata in the database 224 as shown in FIG. 4 for explaining the online application providing apparatus 100 in accordance with the embodiment of the present invention.

A developer develops an application by using the stored UI component when the developer develops the application on an online application developing apparatus. The developer develops the application in consideration of a fixed field without considering a flexible field. A tenant manager chooses and sets a flexible field when setting the corresponding application by using a configurator and uses the additional flexible field. Then, a user uses application by using data shown in the UI regardless of the fixed field and the flexible field.

When the developed application is provided from the online application providing apparatus 100, the tenant manager sets the UI of the application for each tenant by using the configurator. Here, the tenant manager may modify the position of each UI component and add data field other than basic data field set in the database 224 with the flexible field.

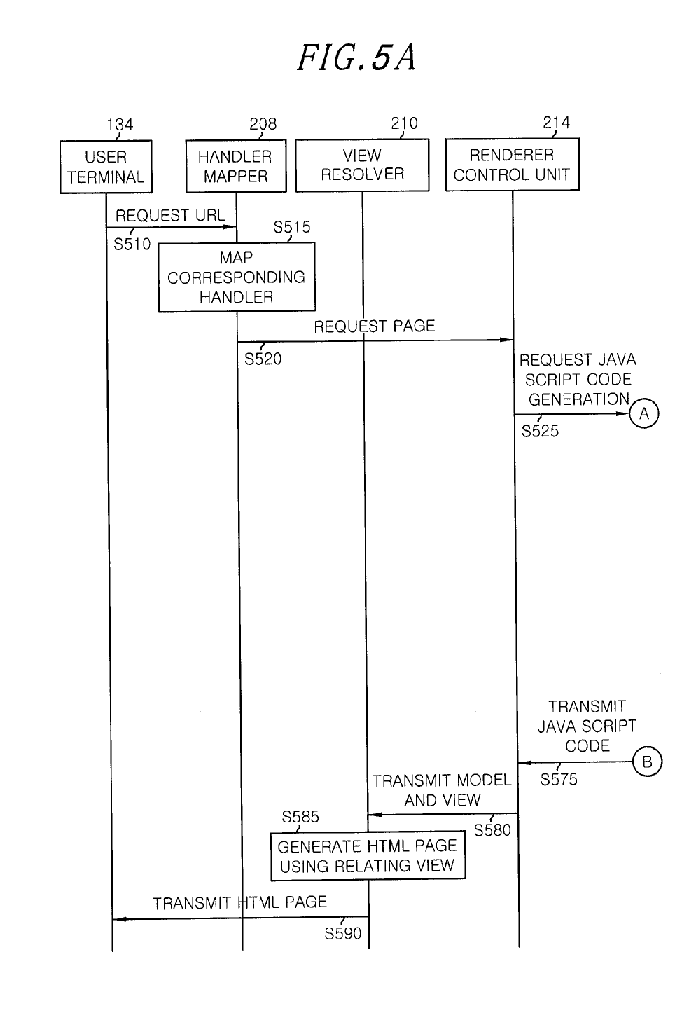

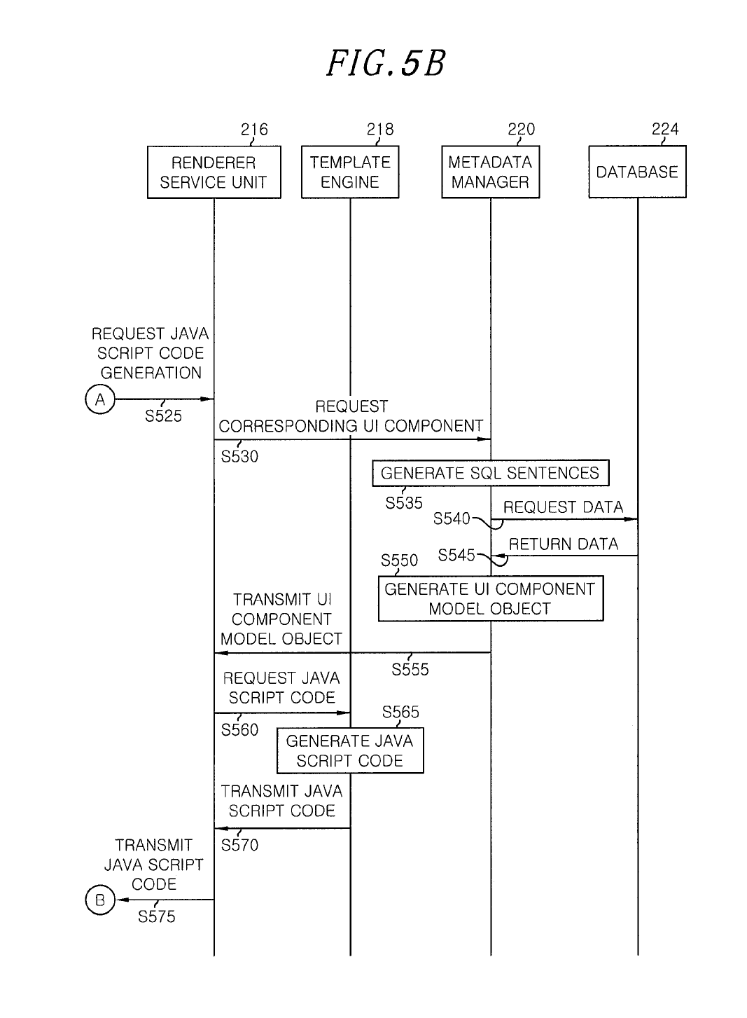

FIGS. 5A and 5B illustrate a flowchart of a rendering process of a web based UI in the online application providing apparatus 100 in accordance with the embodiment of the present invention.

Firstly, when the specific page URL of a specific tenant is requested via the web browser of the user terminals 134 or 154 in a tenant in step S510, the handler mapper 208 in the online application providing apparatus 100 performs the mapping of a handler corresponding to the transmitted URL request in step S515.

Herein, the handler mapper 208 transmits the specific page URL request of the specific tenant to the renderer control unit 214 in step S520 and a tenant ID and a page ID as parameters are continuously transmitted when the page is requested.

Then, the renderer control unit 214 requests generating a javascript code for configuring the corresponding page to the renderer service unit 216 in step S525. According to this, the renderer service unit 216 requests a UI component model object for the corresponding page to the metadata manager 220 in step S530.

As described above, when the UI component model object is requested from the renderer service unit 216, the metadata manager 220 dynamically generates SQL sentences for bring appropriate data from the database 224 in step S535 and requests the corresponding data to the database 224 in step S540.

Then, the database 224 returns UI metadata such as in the following table 3 to the metadata manager 220 in step S545 and the metadata manager 220 generates a UI component model object by converting the received data into object type data in step S550. Then, the metadata manager 220 transmits the UI component model object to the renderer service unit 216 in step S555.

TABLE 3

| Comp. ID | Comp. Type | Attr. ID | Attr. Name | Store URL | Label |
|---|---|---|---|---|---|
| 1 | Grid Panel | null | null | /getProductList.do | product |
| | | | | | list |
| 2 | Grid | 1 | PRODUCT_NAME | null | product |
| | Column | | | | name |
| 3 | Grid | 2 | C_FLEX1 | null | flexible |
| | Column | | | | field |

According to this, the renderer service unit 216 requests generating the javascript for making a UI by transmitting the UI component model object with a template code and a hash map for the corresponding UI to the template engine 218 as shown in the following tables 4 and 5 in step S560.

TABLE 4
[ Template Code ]

```
  GridStore = function( ){
      GridStore.superclass.constructor.call(this,
  {
      remoteSort : true,
      proxy: new Ext.data.HttpProxy({
        url: ‘$storeUrl’
      })
      reader: new Ext.data.JsonReader({
      [{
          name: ‘$dataIndex’,
          mapping: ‘$label’
      }]
      })
    });
};
```

TABLE 5
[ Hash Map ]

```
storeUrl : ‘/getProductList.html’
{
    dataIndex[0]: ‘PRODUCT_NAME’
    label[0]: ‘product name’
    dataIndex[1]: ‘C_FLEX1’
    label[1]: ‘flexible field’
}
```

Herein, the template code for each UI component should be predefined and a changed part in the template code is expressed as a variable as shown in the table 4.

The template engine 218 generates a javascript code corresponding to the UI as shown in the following table 6 in step S565 and returns the javascript code to the renderer service unit 216 in step S570.

TABLE 6

```
GridStore = function( ){
    GridStore.superclass.constructor.call(this,
{
    remoteSort : true,
    proxy: new Ext.data.HttpProxy({
      url: ‘/getProductList.html’
    })
    reader: new Ext.data.JsonReader({
    [{
      name: ‘PRODUCT_NAME’,
      mapping: ‘product name’
      },
      {
      name: ‘C_FLEX1’,
      mapping: ‘flexible field’
    }]
    })
  });
};
```

Here, other than generating the javascript code in the template engine 218 by using the template code and the hash map, a module which able to generate Button class and Grid class for each UI component by using java class and to generate a javascript code by applying the inheritance concept of java can be used instead of the template engine 218.

Then, the renderer service unit 216 transmits the javascript which has been transmitted from the template engine 218 to the renderer control unit 214 in step S575. Herein, it should be designated with a parameter presenting a view to be used.

Then, the renderer control unit 214 generates a model and view object by using the javascript and returns the model and view object to the view resolver 210 in step S580. According to this, the view resolver 210 generates a view suitable for the corresponding the UI, e.g., a HTML page by using productuil.jsp in step S585 and transmits the view to the web browser of the user terminal 134 in step S590.

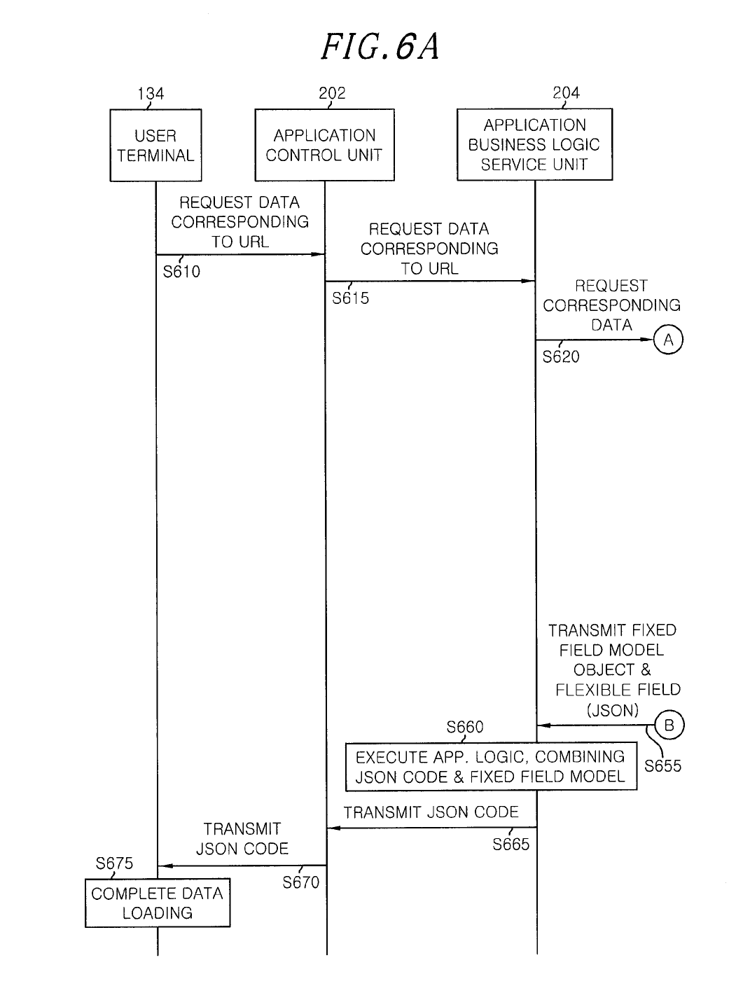

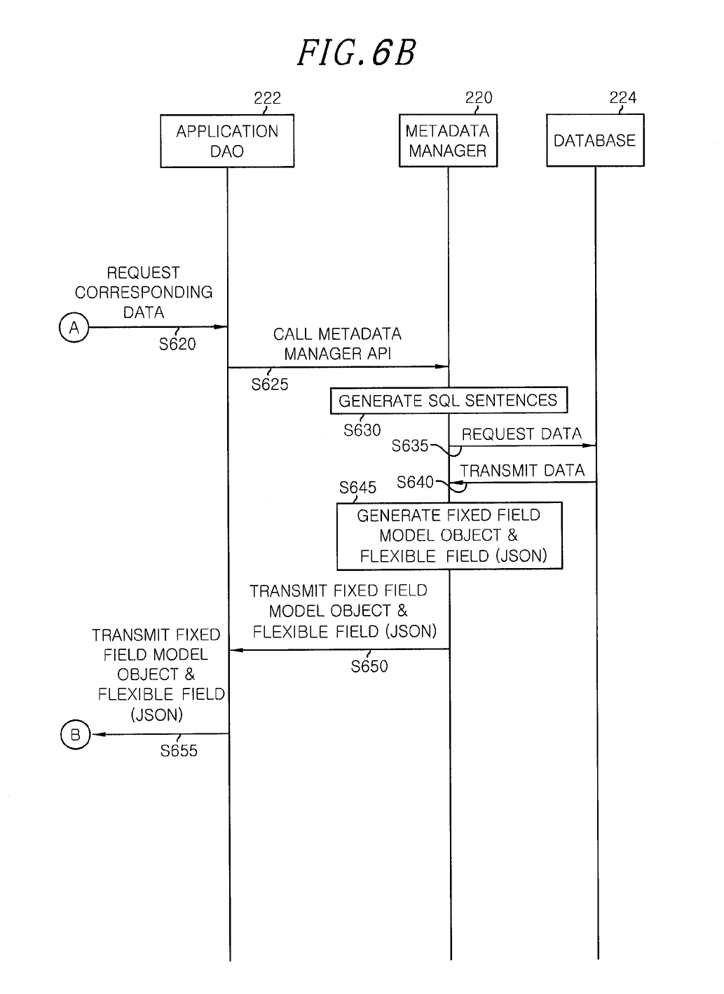

FIGS. 6A and 6B show a flowchart in which the web browser of a user terminal brings an actual data for loading the web page from an online application providing apparatus 100 in accordance with the embodiment of the present invention.

FIGS. 6A and 6B show an example that the web browser of the user terminal 134 brings actual data for the UI generated in the previously shown FIGS. 5A and 5B. When the UI is operated in a web browser, a data loading is automatically requested.

Different from UI rendering case explained in FIGS. 5A and 5B, since actual data relates to an application, URL is requested to the application control unit 202 as a parameter, e.g., getProductLst.html.

If this URL is requested as a parameter, data corresponding to the URL is returned as JSON or XML code type. The data can be interpreted as a javascript type generated above.

First, the web browser of the user terminal 134 requests the data corresponding to the URL to the application control unit 202 in step S610.

Then, the application control unit 202 calls a corresponding method to the application business logic service unit 204 and requests the data in step S615.

The application business service unit 204 requests the data corresponding to URL to the application DAO 222 in step S620 and the application DAO 222 calls the API of the metadata manager 220 in step S625. Herein, necessary field name is included as a parameter in the API call as shown in the following table 7.

TABLE 7

Function Name
- Select( )
Params
- Tenantld : Integer : in
- TableName : String : in
- FieldName : String : in
- Fixed Field : Model : out
- Flexible Field : JSON : out

Then, the metadata manager 220 dynamically generates SQL sentences for bring data corresponding to the parameter requested above in step S630. In addition, the metadata manager 220 requests necessary data to the database 224 by using the generated SQL sentence in step S635. The database 224 extracts the necessary data including a flexible field and returns the necessary data to the metadata manager 220 as shown in the following table 8 in step S640.

TABLE 8

| PRODUCT_NAME | C_FLEX1 | TENANT_ID |
|---|---|---|
| Pencil | pencil explanation (flexible | 1 |
| | field) | |
| ball pen | ball pen explanation (flexible | 1 |
| | field) | |
| Eraser | eraser explanation (flexible | 1 |
| | field) | |
| Highlighter | highlighter | 1 |
| | explanation (flexible field) | |

According to this, in step S645, the metadata manager 220 generates relation data into a model object as shown in the following table 9, generates the flexible field data into JSON type or XML code type as shown in the following table 10, according to the API parameter, and transmits them to the application DAO 222 in step S650.

TABLE 9
PRODUCT_NAME

pencil
ball pen
eraser
highlighter

TABLE 10

```
{
  C_FLEX1 :
  {
    ‘pencil explanation (flexible field)’ ,
    ‘ball pen explanation (flexible field)’ ,
    ‘eraser explanation (flexible field)’ ,
    ‘highlighter explanation (flexible field)’
  }
}
```

Then, the application DAO 222 transmits the fixed field model objects, the flexible field data of JSON type or XML code type which has been transmitted from the metadata manager 220 to the application business logic service unit 204 in step S655.

The application business logic service unit 204 unifies the flexible field data and fixed field model object transmitted from the application DAO 222 into the JSON type or the XML code type by performing calculation to data of the fixed field model object in step S660 as shown in the following table 11. The reason for the unification into the JSON type or the XML code type is that the unified data may be interpreted as a javascript type as described above.

TABLE 11

```
  [{
    PRODUCT_NAME : ‘pencil’ ,
  }
  {
    PRODUCT_NAME : ‘ball pen’ ,
  }
  {
    PRODUCT_NAME : ‘eraser’ ,
  }
  {
    PRODUCT_NAME : ‘highlighter’ ,
  }
  C_FLEX1 :
    {
      ‘pencil explanation (flexible field)’ ,
      ‘ball pen explanation (flexible field)’ ,
      ‘eraser explanation (flexible field)’ ,
      ‘highlighter explanation (flexible field)’
}]
```

As described above, the unified code is transmitted to application control unit 202 in step S665, the application control unit 202 transmits the unified code to the web browser of the user terminal 134 in step S670. Then, in step S675, the actual data loading is completed for the previously generated UI by filling the javascript with the corresponding data (the unified code) transmitted from the application control unit 202.

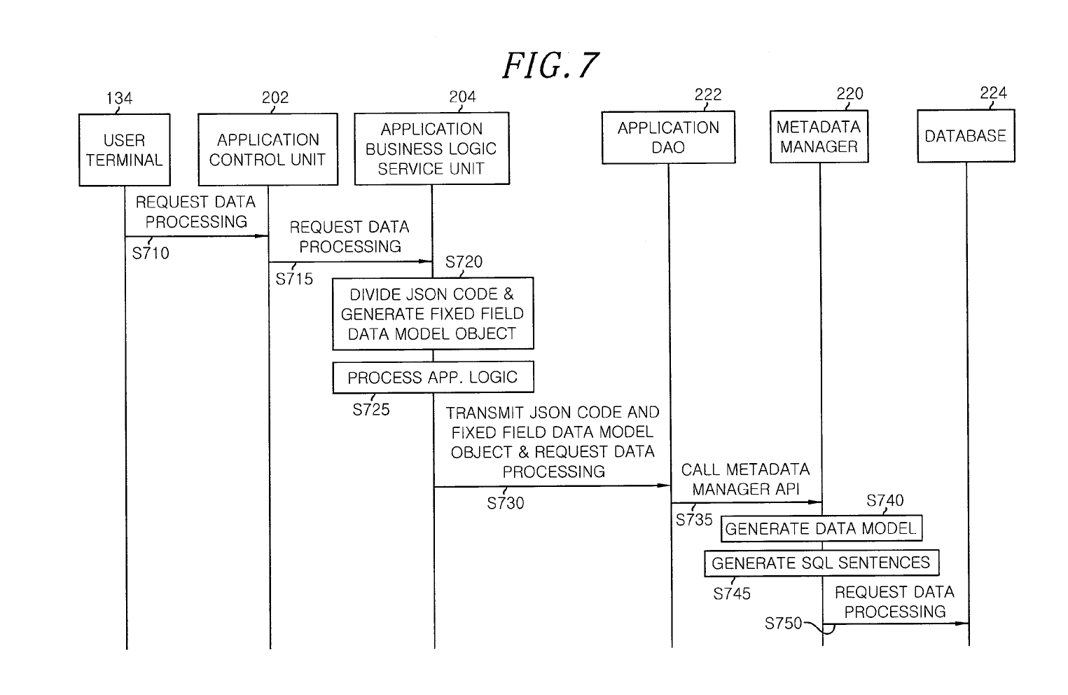

FIG. 7 is a flowchart showing data storing or updating process of a user terminal 134 by an online application providing apparatus 100 in accordance with the embodiment of the present invention.

In order to perform storing or updating of data internally after logic by using the data of JSON or XML code type, a data process request is transmitted from the web browser of the user terminal 134 to the application control unit 202 in step S710.

Then, the application control unit 202 calls the application business logic service unit 204 for performing the requested data process and transmits the data process request transmitted from the user terminal 134 to the called application business logic service unit 204 in step S715.

According to this, the application business logic service unit 204 generates a fixed field data model object by separating flexible field data from the data to be stored or updated in step S720 and performs internal application logic process by using the fixed field data model object in step S725 and transmits data process request to the application DAO 222 in step S730.

Herein, the data process is requested while the code type data, i.e., the JSON code type or the xml code type, of the flexible field data and the fixed field data model object are transmitted to the application DAO 222 in order for the storing and updating of the data.

According to this, the application DAO 222 calls the API of the metadata manager 220 corresponding to the operation of the storing or the updating of the data as shown in the following table 12 step S735.

TABLE 12

Function Name
- Update( )
Params
- Tenantld : Integer : in
- TableName : String : in
- FieldName : String : in
- Fixed Field : Model : in
- Flexible Field : JSON : in

Then, the metadata manager 220 generates a data model by using the inputted values, i.e., the code type data of the flexible field and the fixed field data model object, in step S740. The metadata manager 220 dynamically generates SQL sentences for storing the generated data model in the database 224 or updating the generated data model in step S745 and performs the data process request therefor to the database 224 in step S750.

As described above, each individualized online application for a plurality of tenants is provided by setting the application as a customized application for each tenant by using the flexible field and metadata other than the conventional fixed data field in online application apparatus and a method by use of flexible field in accordance with the embodiments of the present invention.

In addition, tenants expressed as users or a user group can be supported with one application instance by modifying one application into an individual application for each tenant through a metadata and providing the individual application.

Furthermore, since a plurality of the tenants can be supported with one application instance and easily customized for each tenant, costs for customizing is small. In addition, service providing cost can be smaller by popping up one application instance without popping up application instance for each tenant and thus, economy of scale for improving incomes can be realized.

In addition, the defect of the ASP, which cannot realize the economy of scale, can be repaired by sharing the conventional fixed database resource. Furthermore, opportunity cost such as management cost for application and hardware management and purchase cost can be minimized by providing individual application customized for tenant through internet without installing the application in the terminal of the user in the tenant.

While the invention has been shown and described with respect to the embodiments, it will be understood by those skilled in the art that various changes and modification may be made without departing from the scope of the invention as defined in the following claims.

What is claimed is:

1. An online application providing apparatus comprising:
a rendering unit;
a metadata manager;
a database; and
a view resolver,
wherein when a web page URL is requested from a user terminal in a tenant connected with the online application providing apparatus via a communication network, the rendering unit requests UI data to the metadata manager for generating code data corresponding to the URL and provides, to the view resolver, the code data to which a flexible field corresponding to a UI page for the tenant is applied,
wherein, when the request of the UI data for generating the UI page is received from the rendering unit, the metadata manager requests necessary data for processing the request to the database, and transmits the UI data generated based on the necessary data received from the database in response to the request to the rendering unit,
wherein, when the database receives the request of the necessary data, the database extracts corresponding data to the request and provides the extracted data to the metadata manager, and
wherein, the view resolver generates an actual web based UI code by using the code data provided from the rendering unit and transmits the actual web based UI code to the user terminal.

2. The apparatus of claim 1, wherein the rendering unit includes
a renderer control unit; and
a renderer service unit,
wherein when the web page URL is requested from the user terminal, the renderer control unit requests generating the code data for configuring the UI page of the URL requested from the user terminal to the renderer service unit, and
wherein the renderer service unit requests the UI data for generating the code data to the metadata manager, receives the UI data, requests generating the code data for the UI page to a template engine and transmits the code data received from the template engine to the renderer control unit.

3. The apparatus of claim 1, wherein the metadata manager dynamically generates SQL sentences for bringing the corresponding data to the request from the database, generates a UI data model object as the UI data by converting the corresponding data received from the database into object type data and transmits the UI data model object to the rendering unit.

4. An online application providing apparatus comprising:
an application unit;
a metadata manager; and
a database,
wherein when a data request of actual application data for a UI occurs from a user terminal in a specific tenant connected via a communication network with the online application providing apparatus, the application unit selects an application business logic corresponding to the data request and requests the data to the metadata manager,
wherein the metadata manager requests corresponding data to the database for processing the request, receives the corresponding data from the database and converts the received data into fixed field model object and a specific code type of flexible field data, and
wherein when the corresponding data for processing the request is requested, the database extracts the corresponding data and transmits the extracted data to the metadata manager.

5. The apparatus of claim 4, wherein the application unit includes:
an application control unit; and
an application business logic service unit,
wherein when the data request for the UI loading from the user terminal exists, the application control unit transmits the data request by calling a method of the application business logic service unit for processing the data request, and
wherein when the application business logic service unit receives the data request, the application business logic service unit calls an API of the metadata manager for processing the data request, receives, from the metadata manager, the fixed field model object and the flexible field data and unifies the fixed field model object and the flexible field data into data of a JSON type or a XML code type to transmit to the user terminal.

6. The apparatus of claim 4, wherein the metadata manager requests the corresponding data to the database by dynamically generating SQL sentences, generates relation data of a fixed field as the fixed field model object and generates the flexible field data in a JSON type of a XML code type by using the corresponding data received from the database according to the request.

7. An online application providing apparatus comprising:
an application unit;
a metadata manager; and
a database,
wherein when storing or updating data is requested from a user terminal in a specific tenant connected via a communication network with the online application providing apparatus, the application unit separates the data to be stored or updated into code type data of a flexible field and a fixed field model object,
wherein the metadata manager generates a data model by using the code type data of the flexible field and the fixed field model object separated from the data requested to be stored or updated and requests for the storing or the updating the database, and
wherein the database performs the storing or the updating of the data by using the data model.

8. The apparatus of claim 7, wherein the application unit includes:
an application control unit; and
an application business logic service unit,
wherein when the request for storing or updating the data is requested from the user terminal, the application control unit calls the application business logic service unit for performing the storing or the updating the data, and
wherein the application business logic service unit separates the code type data of the flexible field and the fixed field model object from the data to be stored or updated and calls an API of the metadata manager for an operation of the storing or the updating the data.

9. The apparatus of claim 8, wherein the application business logic service unit generates the data of the flexible field separated from the data in a JSON type or a XML code type.
